(19) United States
(12) Patent Application Publication
(10) Pub. No.: US 2006/0214042 A1
(43) Pub. Date: Sep. 28, 2006

(54) Tape reel, cartridge case, information recording medium, and molding mold

(75) Inventors: Hiroki Suzuki, Tokyo (JP); Takateru Satoh, Tokyo (JP); Morimasa Sasaki, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/090,018

(22) Filed: Mar. 28, 2005

(51) Int. Cl. G11B 23/107

(52) U.S. Cl. 242/338.1; 242/348

(57) ABSTRACT

A tape reel is constructed so as to be locked in a non-rotatable state by a locking member that is energized toward a base plate of a hub in the form of a bottomed cylinder and so that the non-rotatable state is released by a lock releasing member disposed between the base plate and the locking member. The base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts that contact the rear surface of the lock releasing member in the non-rotatable state are formed so as to protrude in a periphery of the through-holes on an inner surface of the outer circumferential surface.

### BACKGROUND OF THE INVENTION

1. Field of the Invention

The present invention relates to a tape reel with a hub in the form of a bottomed cylinder, a cartridge case, an information recording medium, and a molding mold constructed so as to be able to mold the tape reel.

2. Description of the Related Art

As one example of an information recording medium that can record a large amount of data, a magnetic tape cartridge disclosed by Japanese Laid-Open Patent Publication No. 2002-319266 is known. This magnetic tape cartridge includes a cartridge case and a tape reel (reel) in the form of a bottomed-cylinder that is enclosed inside the cartridge case so as to be rotatable and around an outer circumference of which magnetic tape is wound. When this magnetic tape cartridge is not in use, the tape reel is locked in a non-rotatable state by a locking member that is energized by a coil spring. This magnetic tape cartridge is also constructed so that during use, a drive gear on a rotational driving member in a drive apparatus and a reel gear formed on a lower surface of a base wall of the tape reel engage each other and are chucked. Here, a lock releasing member (releasing member) is disposed between the base wall of the tape reel and the locking member, and by pressing up legs of the lock releasing member, which pass through through-holes formed in the base wall, with the rotational driving member of the drive apparatus, a main body of the lock releasing member (a plate-like main body) presses up the locking member, resulting in the non-rotatable state (locked state) of the reel being released.

By investigating the magnetic tape cartridge described above, the present inventors discovered the following problems. In this magnetic tape cartridge, the locking of the tape reel is released by pressing up the legs of the lock releasing member with the rotational driving member of the drive apparatus. In this case, to smoothly lock and release the locking of the tape reel, it is preferable that in the locked state, the tips of the legs become flush or substantially flush with the outer edges of the reel gear, for example. On the other hand, the lock releasing member of the magnetic tape cartridge is manufactured by injection molding resin. This means that there are cases where the injection molded resin shrinks after molding due to the resin characteristics. Accordingly, due to such shrinkage, as shown in FIG. 13, for example, there are cases where a main body 405 of a lock releasing member 404 slightly warps toward legs 406. In a state where the main body 405 is warped in this way, even if the lengths of the legs 406 of the lock releasing member 404 have been formed at the stipulated length, as shown in FIG. 13 for example, there are cases where the tips of the legs 406 protrude downward from the base wall 402 beyond the outer edges of the reel gear 403 formed on the base wall 402 of the tape reel 401. This means that when the lock releasing member 404 is warped in this way, there is the risk of problems such as the legs 406 of the lock releasing member 404 catching when the magnetic tape cartridge is inserted into a drive apparatus and/or the lock being released before the drive gear of the rotational driving member of the drive apparatus and the reel gear 403 of the tape reel 401 are chucked.

### SUMMARY OF THE INVENTION

The present invention was conceived in view of the problems described above, and it is an object of the present invention to provide a tape reel, a cartridge case, and an information recording medium that can eliminate problems due to warping of the lock releasing member, and a molding mold that can easily manufacture the tape reel.

To achieve the stated object, a tape reel according to the present invention is constructed so as to be locked in a non-rotatable state by a locking member that is energized toward a base plate of a hub in the form of a bottomed cylinder and so that the non-rotatable state is released by a lock releasing member disposed between the base plate and the locking member, wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts, which contact the rear surface of the lock releasing member in the non-rotatable state, are formed so as to protrude in a periphery of the through-holes on an inner surface of the outer circumferential part.

A cartridge case according to the present invention includes: a tape reel constructed so as to be locked in a non-rotatable state by a locking member that is energized toward a base plate of a hub in the form of a bottomed cylinder and so that the non-rotatable state is released by a lock releasing member disposed between the base plate and the locking member; and a case main body that encloses the tape reel in a rotatable state, wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts, which contact the rear surface of the lock releasing member in the non-rotatable state are formed so as to protrude in a periphery of the through-holes on an inner surface of the outer circumferential part.

An information recording medium according to the present invention includes: a tape reel constructed so as to be locked in a non-rotatable state by a locking member that is energized toward a base plate of a hub in the form of a bottomed cylinder and so that the non-rotatable state is released by a lock releasing member disposed between the base plate and the locking member; a case main body that encloses the tape reel in a rotatable state; and a magnetic tape wound around the tape reel, wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts, which contact the rear surface of the lock releasing member in the non-rotatable state are formed so as to protrude in a periphery of the through-holes on an inner surface of the outer circumferential part.

For the above tape reel, cartridge case, and information recording medium, contact parts that contact the rear surface of the lock releasing member in the non-rotatable state of the tape reel are formed so as to protrude in a periphery of the through-holes in the base surface. In this case, when the lock releasing member is warped toward the front ends of the legs, for example, the rear surface of the lock releasing member can be placed in contact with the contact parts, so that unlike a construction where contact parts are not formed, regardless of how the lock releasing member may or may not be warped, the front ends of the legs can become flush or substantially flush with the outer edges of driven teeth formed in an outer surface of the base plate of the tape reel. Accordingly, with the above tape reel, cartridge case, and information recording medium, problems due to the lock releasing member being warped, such as the legs of the lock releasing member catching on a loading part of a drive apparatus when the information recording medium is inserted into a drive apparatus and/or the non-rotatable state of the tape reel being released before the drive shaft of the drive apparatus and the tape reel are chucked, can be reliably prevented.

A molding mold according to the present invention is constructed so as to be able to form a cavity for molding a main body of a tape reel constructed so as to be locked in a non-rotatable state by a locking member energized toward a base plate of a hub in the form of a bottomed cylinder and so that the non-rotatable state is released by a lock releasing member disposed between the base plate and the locking member, wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts that contact the rear surface of the lock releasing member in the non-rotatable state are formed so as to protrude in a periphery of the through-holes on an inner surface of the outer circumferential surface, wherein base surfaces of concave parts that form the contact parts in the cavity are constructed by front end surfaces of eject pins.

In this molding mold, the base surfaces of the concave parts that form the contact parts inside the cavity are composed of the front end surfaces of the eject pins. This means that by changing the lengths of the eject pins, the depths of the concave parts, that is, the heights of the contact parts of the main part of the tape reel molded using the above molding mold can be easily and reliably changed. As a result, by changing the lengths of the eject pins in accordance with the degree of warping of the lock releasing member and without making a troublesome correction to the molding mold, for example, it is possible to adjust the heights of the contact parts so that the front ends of the legs and the outer edges of driven teeth formed in the outer surface of a base surface become flush or substantially flush. Accordingly, using the above molding mold, a tape reel, for which problems due to warping of the lock releasing member can be reliably prevented, can be easily and reliably manufactured.

### BRIEF DESCRIPTION OF THE DRAWINGS

These and other objects and features of the present invention will be explained in more detail below with reference to the attached drawings, wherein:

FIG. 1 is an exploded perspective view of an information recording medium;

FIG. 2 is a cross-sectional view of a tape reel around which magnetic tape has been wound;

FIG. 3 is a perspective view of a tape reel;

FIG. 4 is a plan view of a main body of the tape reel;

FIG. 5 is a cross-sectional view of a tape reel that has been cut along the line A-A in FIG. 4;

FIG. 6 is a cross-sectional view of a tape reel and a lock releasing plate that have been cut along the line A-A in FIG. 4 in a state where the lock releasing plate, for which warping of arms of a main body has not occurred, has been set on the tape reel;

FIG. 7 is a perspective view of an upper mold;

FIG. 8 is a perspective view of a lower mold;

FIG. 9 is a cross-sectional view of a molding mold;

FIG. 10 is a cross-sectional view of the molding mold showing the construction of the periphery of a concave part;

FIG. 11 is a cross-sectional view of a tape reel and a lock releasing plate that have been cut along the line A-A in FIG. 4 in a state where the lock releasing plate, for which warping of the arms on the main body has occurred, has been set on the tape reel;

FIG. 12 is a cross-sectional view of a tape reel and a lock releasing plate that have been cut along the line A-A in FIG. 4 in a state where the lock releasing plate, for which warping of the arms on the main body has occurred, has been set on a different tape reel; and

FIG. 13 is a cross-sectional view of a tape reel, on which contact parts have not been formed, and a lock releasing plate.

### DESCRIPTION OF THE PREFERRED EMBODIMENTS

Preferred embodiments of a tape reel, a cartridge case, an information recording medium, and a molding mold according to the present invention will now be described with reference to the attached drawings.

First, the construction of an information recording medium 1 will be described with reference to the drawings.

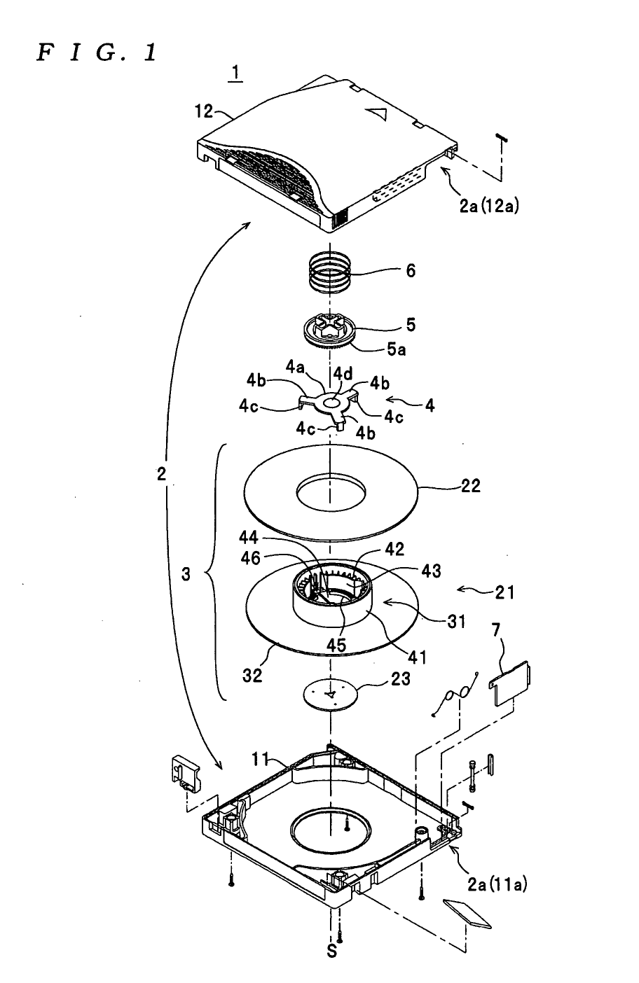

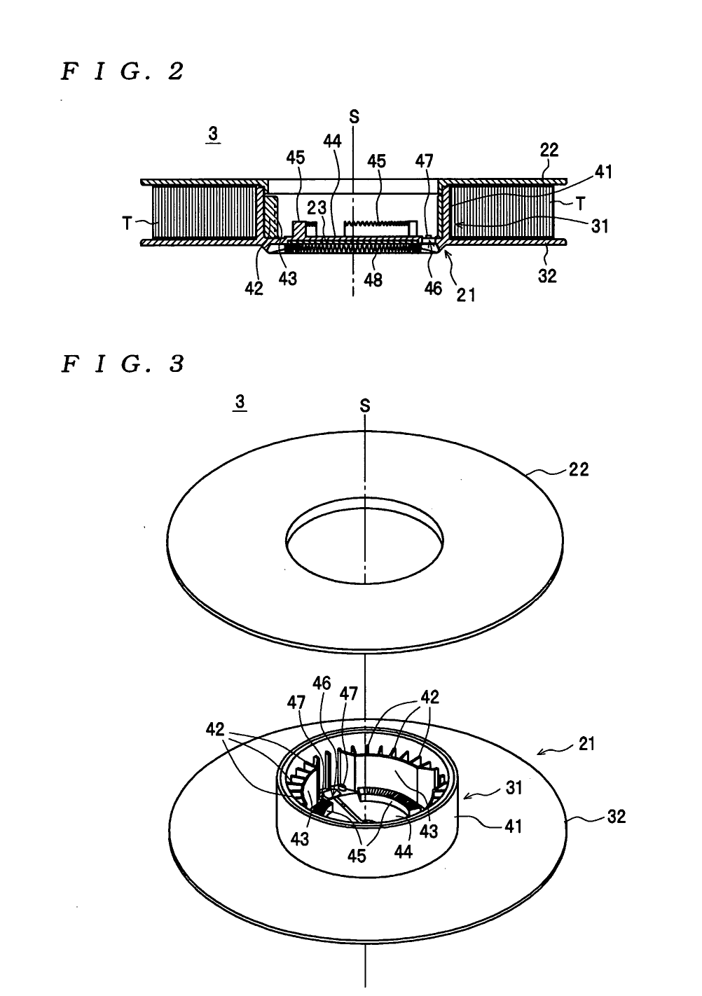

The information recording medium 1 shown in FIG. 1 is a single-reel, cartridge-type information recording medium used as a storage device for backing-up recording data that has been recorded by a computer, for example. As shown in FIG. 1, the information recording medium 1 includes a case main body 2, a tape reel 3, a lock releasing member 4, a locking member 5, a brake spring 6, a door member 7, and a magnetic tape T (see FIG. 2). The components aside from the magnetic tape T construct a cartridge case according to the present invention.

As shown in FIG. 1, the case main body 2 is constructed of a lower case 11 and an upper case 12 that are respectively formed in the shape of shallow plates and can engage one another. The case main body 2 encloses the tape reel 3 in an internal space formed when the upper case 11 and the lower case 12 engage one another so that the tape reel 3 is rotatable. Here, cutaway parts 11a, 12a, which construct a tape withdrawal opening 2a for withdrawing the magnetic tape T wound around the tape reel 3 to the outside, are respectively formed in the lower case 11 and the upper case 12.

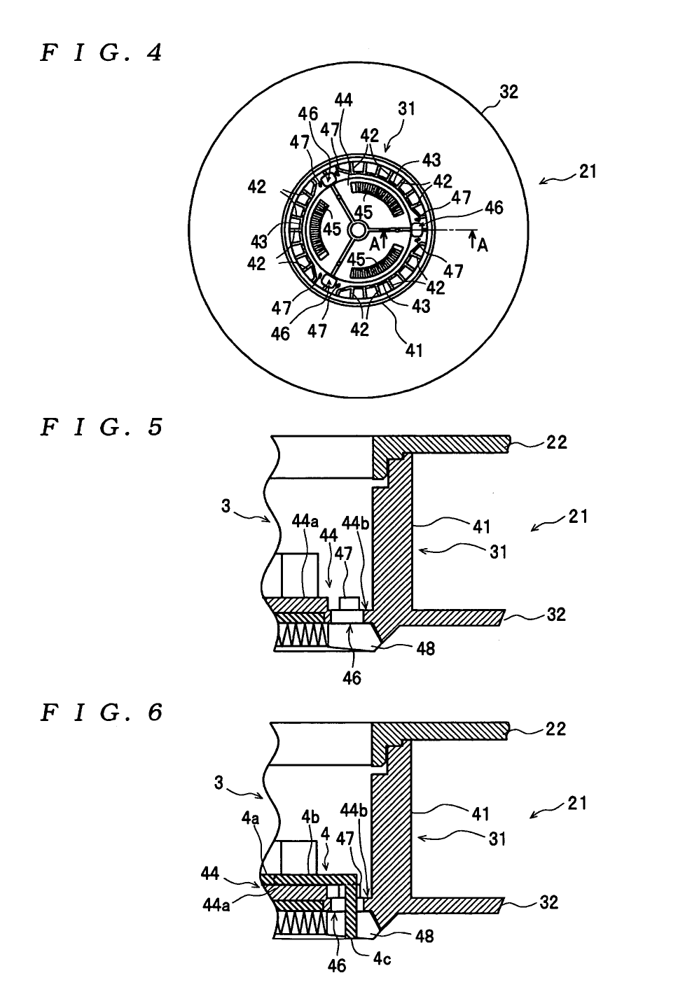

The tape reel 3 is one example of a tape reel according to the present invention and, as shown in FIGS. 2 and 3, includes a main body 21 and an upper flange 22. The main body 21 includes a hub 31 and a lower flange 32. The hub 31 is shaped as a bottomed cylinder where an opening is formed at an upper end, and is constructed so that the magnetic tape T can be wound around a circumference thereof. Also, as shown in FIGS. 3 and 4, in a direction from an upper end of a trunk part 41 of the hub 31 to a lower end, a plurality of reinforcing ribs 42 are formed at equal intervals on an inner circumferential surface of the trunk part 41 so as to protrude toward a central axis S (see FIG. 3) of the hub 31. Inside the trunk part 41, three reinforcing wall members 43 in the form of thin plates are formed so as to connect the respective ends of the reinforcing ribs 42 and to face the inner circumferential surface of the trunk part 41.

As shown in FIG. 5, a base plate 44 of the hub 31 is formed so that an inner surface (upper surface) of a central part 44a is at a higher level than an inner surface of an outer circumferential part 44b. That is, the central part 44a of the base plate 44 of the hub 31 protrudes further toward the upper end of the hub 31 than the outer circumferential part 44b, or in other words, the base plate 44 of the hub 31 is formed so that the outer circumferential part 44b is depressed further toward a lower end of the hub 31 than the central part 44a. In this case, as shown in FIGS. 3 and 4, locking teeth 45 that are arc-shaped when viewed from above and engage teeth 5a (see FIG. 1) of the locking member 5 which is energized by the brake spring 6, are formed on an inner surface of the central part 44a so as to be located on a same circumference around the central axis S of the hub 31. Insertion through-holes 46, through which legs 4c of the lock releasing member 4, described later, can pass so as to be able to move up and down, are formed in the outer circumferential part 44b of the base plate 44 so as to be located on a same circumference around the central axis S of the hub 31. Also, as shown in FIGS. 3 to 5, on both sides (or peripheries thereof) of the respective insertion through-holes 46 on an inner surface in the outer circumferential part 44b of the base plate 44, respective pairs of contact parts 47 (three pairs making a total of six) are formed so as to be positioned on a same circle centered on the central axis S and so as to protrude toward an upper end of the trunk part 41. In this example, the contact parts 47 are formed so as to be oval when viewed from above. The contact parts 47 are formed so that when the tape reel 3 is locked in the non-rotatable state by the locking member 5, upper end surfaces thereof contact rear surfaces of front ends of the arms 4b of the lock releasing member 4. As one example, the upper end surfaces of the contact parts 47 may be formed so as to be flush with the inner surface of the central part 44a. As shown in FIG. 2, a metal plate 23 (see FIG. 1) is attached to an outer surface (lower surface) of the base plate 44 so that a drive shaft of a drive apparatus, not shown, and the hub 31 (the tape reel 3) can be chucked by magnetic force. On the outer surface of the base plate 44, driven teeth 48 that engage driving teeth (not shown) of the drive shaft of the drive apparatus are formed in a ring so as to surround the metal plate 23.

As shown in FIG. 3, the lower flange 32 is constructed in a disc shape and is integrally formed with the lower end of the hub 31. The upper flange 22 is constructed in a disc shape as shown in FIG. 3 and is fixed to the upper end of the trunk part 41 of the hub 31 as shown in FIG. 2.

As shown in FIG. 1, the lock releasing member 4 includes a main part 4a with three arms 4b, three legs 4c that are erected on a rear surface (the lower surface in FIG. 1) of the main part 4a, and a circular metal plate 4d attached to a central part of the front surface (the upper surface in FIG. 1) of the main part 4a, and by inserting the legs 4c through the respective insertion through-holes 46 of the hub 31, the lock releasing member 4 is disposed on the inside of the trunk part 41 of the hub 31 so as to be capable of up-down movement but incapable of relative rotation with respect to the hub 31. In this embodiment, as shown in FIG. 6, the lock releasing member 4 is formed so that the lengths of the legs 4c are equal to or substantially equal to a distance from a surface (the upper surface in FIG. 6) of the central part 44a of the base plate 44 of the hub 31 to the outer edges of the driven teeth 48. As shown in FIG. 1, the teeth 5a that can engage the locking teeth 45 of the hub 31 are formed on the base surface of the locking member 5. Here, the locking member 5 is energized by the brake spring 6 and locks the tape reel 3 in a non-rotatable state due to the teeth 5a engaging the locking teeth 45. The brake spring 6 is composed of a coil spring and is disposed between the upper case 12 and the locking member 5, and energizes the locking member 5 toward the base plate 44 of the hub 31 of the tape reel 3. As shown in FIG. 1, the door member 7 is formed of a thin plate that can close the tape withdrawal opening 2a and is enclosed in guide channels respectively formed in a side wall of the lower case 11 and a side wall of the upper case 12 so as to be able to slide.

Next, the construction of a molding mold 101 will be described with reference to the drawings.

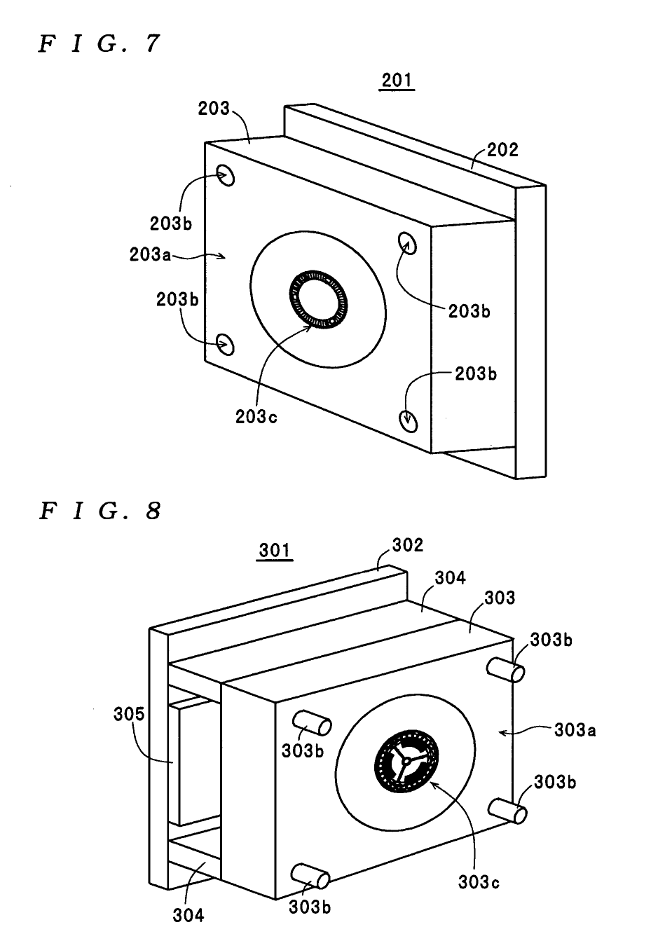

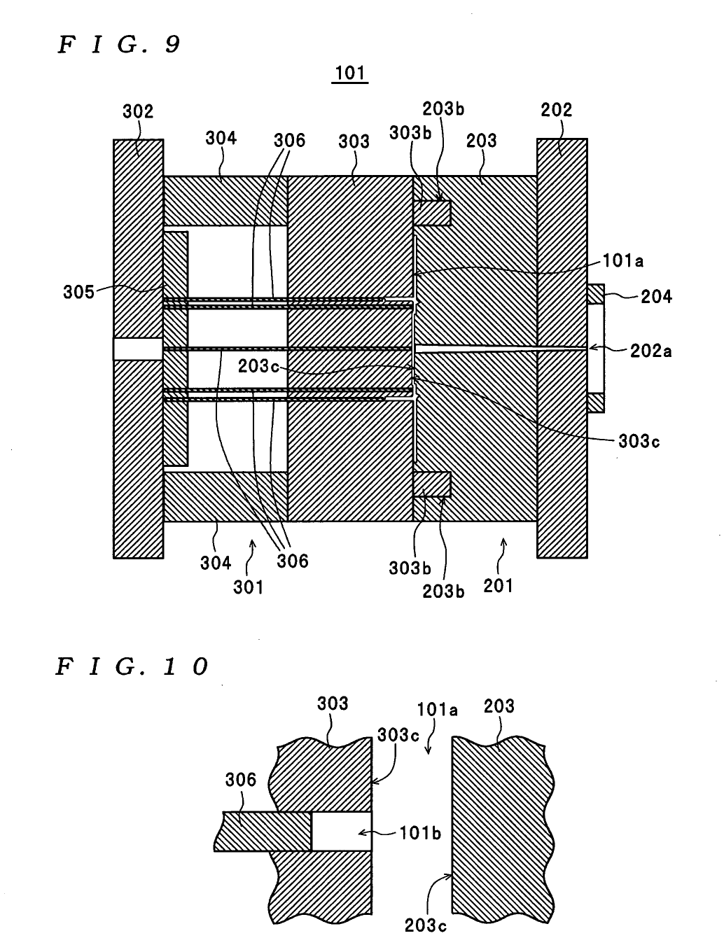

The molding mold 101 shown in FIG. 9 is one example of a “molding mold” for the present invention and includes an upper mold (fixed mold) 201 and a lower mold (moving mold) 301, and is constructed so as to be capable of molding the main body 21 of the tape reel 3 in the information recording medium 1 by having resin injected by an injection molding device into a cavity 101a formed by the upper mold 201 and the lower mold 301. As shown in FIGS. 9 and 7, the upper mold 201 includes a base 202 and a main body 203. The base 202 is formed so as to be plate-like and is constructed so as to be capable of attachment to a fixed-side attaching part of the injection molding device, for example. On a rear surface of the base 202, an inflow opening 202a that is connected to an injection hole of an injection mechanism of the injection molding device to allow molten resin to be injected is formed, with a locating ring 204 for positioning the upper mold 201 during attachment to the fixed-side attaching part of the injection molding device also being attached. The main body 203 is shaped like a thick plate and is fixed to the base 202. Also, guide holes 203b, into which guide pins 303b (see FIG. 8) of the lower mold 301 are inserted to position the two molds 201, 301 when the upper mold 201 and the lower mold 301 are placed in contact, are formed in the four corners of a surface 203a of the main body 203. A molding surface (convex/concave surface) 203c that constructs the cavity 101a for molding the main body 21 of the tape reel 3 is formed in the surface 203a of the main body 203.

As shown in FIGS. 8 and 9, the lower mold 301 includes a base 302, a main body 303, spacer blocks 304, an eject plate 305, and eject pins 306. The base 302 is formed so as to be plate-like and is constructed so as to be capable of being attached to an attaching part of a mold moving mechanism of the injection molding device. The main body 303 is shaped like a thick plate and is fixed to the base 302 via the spacer blocks 304. The guide pins 303b, which are inserted into the guide holes 203b of the upper mold 201 to position the two molds 201, 301 when the upper mold 201 and the lower mold 301 are placed in contact, are formed in the four corners of a surface 303a of the main body 303. A molding surface 303c, which together with the molding surface 203c of the upper mold 201 constructs the cavity 101a, is formed in the surface 303a of the main body 303. The eject plate 305 is disposed between the base 302 and the main body 303 and is moved between the base 302 and the main body 303 by a push-out mechanism of the injection molding device. Eject pins 306 are fixed to a base end of the eject plate 305 and push out a molded product (the main body 21 of the tape reel 3) that has hardened inside the cavity 101a to separate the molded product from the lower mold 301. In this case, as shown in FIG. 10, base surfaces of concave parts 101b for molding the contact parts 47 inside the cavity 101a (the molding surface 303c) are composed of front end surfaces of the eject pins 306. For this reason, by appropriately changing the lengths of the eject pins 306 in the molding mold 101, it is possible to easily change the depths of the concave parts 101b, and as a result, it is possible to easily change the heights of the contact parts 47 from the surfaces of the outer circumferential part 44b.

Next, a method of molding the main body 21 of the tape reel 3 using the molding mold 101 will be described with reference to the drawings.

First, the upper mold 201 and the lower mold 301 are respectively attached to a fixed attaching part and a mold moving mechanism (neither is shown) of the injection molding device so that the surfaces 203a, 303a thereof face one another. At this time, the attachment positions of the two molds 201, 301 are adjusted so that the respective guide pins 303b of the lower mold 301 are inserted into the respective guide holes 203b of the upper mold 201. Next, by driving the injection molding device, the mold moving mechanism moves the lower mold 301 toward the upper mold 201 so that the surface 203a and the front surface 303a are placed in contact with one another. At this time, as shown in FIG. 9, the cavity 101a for molding the main body 21 of the tape reel 3 is formed by the molding surface 203c of the upper mold 201 and the molding surface 303c of the lower mold 301.

Next, by having the injection mechanism inject molten resin from the inflow opening 202a of the base 202 of the upper mold 201, the inside of the cavity 101a is filled with molten resin. After this, after the molten resin has hardened, the mold moving mechanism withdraws the lower mold 301 to separate the lower mold 301 from the upper mold 201. At this time, the molten resin that has hardened (the molded product) is pulled off the upper mold 201 as the lower mold 301 is withdrawn in a state where the molded product fits in the lower mold 301. Next, the eject plate 305 of the lower mold 301 is pushed forward by an eject mechanism of the injection molding device. At this time, the eject pins 306 attached to the eject plate 305 press out the molded product from a rear part of the lower mold 301. By doing so, the main body 21 is molded. In this case, as described above, in the molding mold 101, the base surfaces of the concave parts 101b for molding the contact parts 47 inside the cavity 101a are constructed by the front end surfaces of the eject pins 306, and by changing the lengths of the eject pins 306, for example, the depths of the concave parts 101b, that is, the heights of the contact parts 47 can be easily and reliably changed.

Next, the operation during recording and reproduction of the information recording medium 1 that includes the main body 21 (the tape reel 3) manufactured using the molding mold 101 will be described with reference to the drawings.

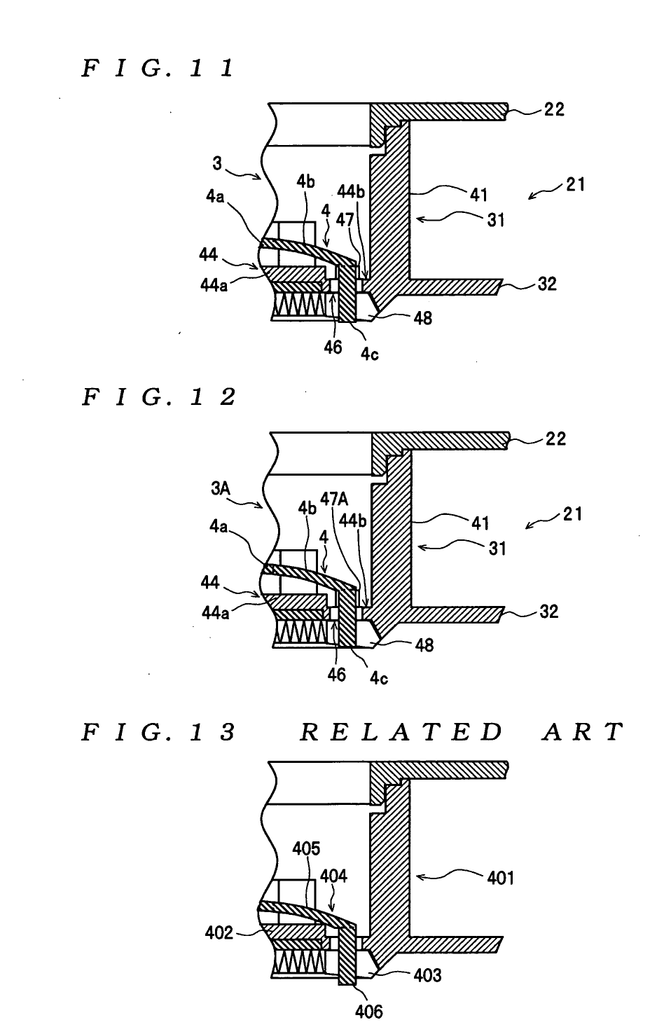

In a state where the information recording medium 1 has been removed from a drive apparatus, not shown, that is, in a state where the information recording medium 1 is not in use, the locking member 5 is energized by the brake spring 6 and is moved toward the base plate 44 of the hub 31 while pressing the lock releasing member 4. In this state, the teeth 5a of the locking member 5 are placed in engagement with the locking teeth 45 of the hub 31, so that the tape reel 3 is locked in a non-rotatable state. In this state, as shown in FIG. 6, for example, when there is no warping in the arms 4b of the main part 4a of the lock releasing member 4, the main part 4a makes surface contact with the central part 44a of the base plate 44 of the hub 31 and the front ends of the legs 4c become flush with the outer edges of the driven teeth 48 of the hub 31. On the other hand, as shown in FIG. 11, in an information recording medium 1 where the arms 4b of the main part 4a of the lock releasing member 4 are warped toward the front ends of the legs 4c, rear surfaces of both sides of the front ends of the arms 4b contact the front ends of the contact parts 47, and the central part of the main part 4a is placed in a state that floats slightly above the central part 44a of the base plate 44. It should be noted that this floating state is exaggerated in FIG. 11. Accordingly, unlike a construction where the contact parts 47 are not formed, even when the arms 4b of the main part 4a are warped, for example, the front ends of the legs 4c will still become flush or substantially flush with the outer edges of the driven teeth 48. Accordingly, when the information recording medium 1 is not in use, regardless of how the arms 4b of the main part 4a of the lock releasing member 4 may or may not be warped, the front ends of the legs 4c become flush or substantially flush with the outer edges of the driven teeth 48.

On the other hand, when the information recording medium 1 is loaded into a drive apparatus, the information recording medium 1 is inserted via an insertion slot of the drive apparatus. At this time, the front ends of the legs 4c of the lock releasing member 4 will be flush or substantially flush with the outer edges of the driven teeth 48 of the hub 31, so that the front ends of the legs 4c are reliably prevented from catching on the loading part of the drive apparatus. Next, the door member 7 of the information recording medium 1 loaded into the loading part is slid by the drive apparatus to open the tape withdrawal opening 2a. After this, as one example, the loading part moves the information recording medium 1 a predetermined amount toward a front end of a drive shaft inside the drive apparatus, so that the front ends of the legs 4c of the lock releasing member 4 are pressed toward the locking member 5 by the drive shaft, resulting in the engagement of the teeth 5a of the locking member 5 and the locking teeth 45 of the hub 31 (i.e., the locking of the tape reel 3 by the locking member 5) being released. In addition, driving teeth disposed on the front end of the drive shaft engage the driven teeth 48 of the hub 31, and the metal plate 23 of the tape reel 3 is attached to the front end of the drive shaft by magnetic force, thereby chucking the driving axis and the tape reel 3. In this example, the front ends of the legs 4c and the outer edges of the driven teeth 48 are flush or substantially flush without the front ends of the legs 4c projecting further downward from the base plate 44 than the outer edges of the driven teeth 48. This means that the locking of the tape reel 3 is prevented from being released before the information recording medium 1 is moved the predetermined amount, that is, the locking of the tape reel 3 is prevented from being released before the drive shaft and the tape reel 3 are chucked, so that a loosening of the magnetic tape T is also reliably prevented.

Next, the drive apparatus withdraws the magnetic tape T wound around the tape reel 3 from the tape withdrawal opening 2a to outside the case main body 2. Next, a tape reel in the drive apparatus winds the magnetic tape T, the drive shaft of the drive apparatus rotates at a rotational speed in accordance with a withdrawal speed of the magnetic tape T, and together with this, the tape reel 3 rotates. Here, since the locking by the locking member 5 has been reliably removed, the tape reel 3 rotates smoothly.

Next, when the recording and/or reproduction of data by the drive apparatus has ended and the magnetic tape T has been wound back onto the tape reel 3 by the drive apparatus, the loading part has the information recording medium 1 separated from the front end of the drive shaft. At this time, the locking member 5 energized by the brake spring 6 presses the lock releasing member 4 and causes the lock releasing member 4 to move toward the base plate 44 of the hub 31, the teeth 5a of the locking member 5 are engaged by the locking teeth 45 of the hub 31, and as a result the tape reel 3 is locked in a non-rotatable state. In this state, as shown in FIG. 6 for example, when the arms 4b on the main part 4a of the lock releasing member 4 are not warped, the main part 4a makes surface contact with the central part 44a of the base plate 44 of the hub 31, and the front ends of the legs 4c become flush with the outer edges of the driven teeth 48 of the hub 31. On the other hand, as shown in FIG. 11, in an information recording medium 1 where the arms 4b on the main part 4a of the lock releasing member 4 are warped toward the front ends of the legs 4c, rear surfaces of both sides at the front ends of the arms 4b contact the front ends of the contact parts 47, so that the front ends of the legs 4c will still become flush or substantially flush with the outer edges of the driven teeth 48. Accordingly, in the same way as the unused state described above, regardless of how the arms 4b of the main part 4a of the lock releasing member 4 may or may not be warped, the front ends of the legs 4c become flush or substantially flush with the outer edges of the driven teeth 48. Next, the information recording medium 1 is removed from the loading part of the driving apparatus. At this time, since the front ends of the legs 4c of the lock releasing member 4 become flush or substantially flush with the outer edges of the driven teeth 48 of the hub 31, the situation where the front ends of the legs 4c catch on the loading part of the drive apparatus is reliably prevented.

In this way, according to the tape reel 3, the cartridge case, and the information recording medium 1, in the locked state of the tape reel 3, the contact parts 47 that contact the rear surface of the main part 4a of the lock releasing member 4 are formed so as to protrude close to the through-holes 46 on the inner surface of the outer circumferential part 44b of the base plate 44, so that for example, if the arms 4b of the main part 4a of the lock releasing member 4 are warped toward the front ends of the legs 4c, the rear surfaces of both sides of the front ends of the arms 4b are still placed in contact with front ends of the contact parts 47. For this reason, unlike a construction where the contact parts 47 are not formed, regardless of how the arms 4b of the main part 4a of the lock releasing member 4 may or may not be warped, the front ends of the legs 4c can be made flush or substantially flush with the outer edges of the driven teeth 48. Accordingly, with the tape reel 3, the cartridge case, and the information recording medium 1, when the information recording medium 1 is inserted in a drive apparatus, problems due to the lock releasing member 4 being warped, such as the legs 4c of the lock releasing member 4 catching on the loading part of the drive apparatus and/or the locking of the tape reel 3 being released before the drive shaft of the drive apparatus and the tape reel 3 are chucked, can be reliably prevented.

It should be noted that the present invention is not limited to the construction described above. For example, although an example where the contact parts 47 are formed so that the upper end surfaces thereof are flush with the inner surface of the central part 44a of the base plate 44 has been described, as shown in FIG. 12, it is possible to use a tape reel 3A that includes contact parts 47A formed so that upper end surfaces thereof protrude slightly further toward an upper end of the trunk part 41 than an inner surface of the central part 44a of the base plate 44. With this construction, as shown in FIG. 12, since the upper end surfaces of the contact parts 47A protrude further than the inner surface of the central part 44a, even if the arms 4b of the main part 4a of the lock releasing member 4 are greatly warped, the front ends of the legs 4c of the lock releasing member 4 can be made flush or substantially flush with the outer edges of the driven teeth 48.

In this case, as described above, in the molding mold 101, the base surfaces of the concave parts 101b for molding the contact parts 47A (the contact parts 47) inside the cavity 101a are constructed by the front end surfaces of the eject pins 306. This means that by changing the length of the eject pins 306, the depths of the concave parts 101b, that is, the heights of the contact parts 47A (the contact parts 47) of the tape reel 3A (the tape reel 3) molded using the molding mold 101 can be easily and reliably changed. As a result, as one example, without making a troublesome correction of the molding mold 101, by changing the length of the eject pins 306 in accordance with the degree of warping of the arms 4b of the main part 4a of the lock releasing member 4, it is possible to adjust the heights of the contact parts 47 so that the front ends of the legs 4c and the outer edges of the driven teeth 48 become flush or substantially flush. Therefore, according to the molding mold 101, it is possible to easily and reliably manufacture the tape reel 3 for which problems due to warping of the lock releasing member 4 can be reliably prevented.

Also, although an example of a tape reel 3 including the reinforcing ribs 42 and the reinforcing wall members 43 has been described above, it is possible to apply the present invention to a tape reel that is not provided with one or both of the reinforcing ribs 42 and the reinforcing wall members 43. Also, although an example where the contact parts 47 are oval when viewed from above has been described, the form of the contact parts is not limited to this, and the contact parts 47 may be formed in a freely chosen shape. Also, although an example including six contact parts 47 has been described, the number of contact parts is not limited to six and it is possible to use any desired number.

What is claimed is:

1. A tape reel constructed so as to be locked in a non-rotatable state by a locking member that is energized toward a base plate of a hub in the form of a bottomed cylinder and so that the non-rotatable state is released by a lock releasing member disposed between the base plate and the locking member,
wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts, which contact the rear surface of the lock releasing member in the non-rotatable state, are formed so as to protrude in a periphery of the through-holes on an inner surface of the outer circumferential part.

2. A cartridge case comprising:
a tape reel constructed so as to be locked in a non-rotatable state by a locking member that is energized toward a base plate of a hub in the form of a bottomed cylinder and so that the non-rotatable state is released by a lock releasing member disposed between the base plate and the locking member; and
a case main body that encloses the tape reel in a rotatable state,
wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts, which contact the rear surface of the lock releasing member in the non-rotatable state are formed so as to protrude in a periphery of the through-holes on an inner surface of the outer circumferential part.

3. An information recording medium comprising:
a tape reel constructed so as to be locked in a non-rotatable state by a locking member that is energized toward a base plate of a hub in the form of a bottomed cylinder and so that the non-rotatable state is released by a lock releasing member disposed between the base plate and the locking member;
a case main body that encloses the tape reel in a rotatable state; and
a magnetic tape wound around the tape reel,
wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts, which contact the rear surface of the lock releasing member in the non-rotatable state are formed so as to protrude in a periphery of the through-holes on an inner surface of the outer circumferential part.

4. A molding mold constructed so as to be able to form a cavity for molding a main body of a tape reel constructed so as to be locked in a non-rotatable state by a locking member energized toward a base plate of a hub in the form of a bottomed cylinder and so that the non-rotatable state is released by a lock releasing member disposed between the base plate and the locking member,
wherein the base plate is formed so that an inner surface of a central part thereof is higher than an inner surface of an outer circumferential part thereof, through-holes, through which legs disposed on a rear surface of the lock releasing member are inserted so as to be capable of up-down movement, are formed in the outer circumferential part, and contact parts that contact the rear surface of the lock releasing member in the non-rotatable state are formed so as to protrude in a periphery of the through-holes on an inner surface of the outer circumferential surface,
wherein base surfaces of concave parts that form the contact parts in the cavity are constructed by front end surfaces of eject pins.
